(19) United States
(12) Patent Application Publication
(10) Pub. No.: US 2023/0062186 A1
(43) Pub. Date: Mar. 2, 2023

(54) SYSTEMS AND METHODS FOR MICROMOBILITY SPATIAL APPLICATIONS

(71) Applicant: Fantasmo Studio Inc., Venice, CA (US)

(72) Inventors: Ryan Thomas MEASEL, Venice, CA (US); Jameson DETWEILER, Venice, CA (US); Rolf LAKAEMPER, Munich (DE); Jan ELSEBERG, Belm (DE); Gordan RISTOVSKI, Munich (DE); Pavel VECHERSKY, Irvine, CA (US); Ilan PENN, Los Angeles, CA (US)

(73) Assignee: Fantasmo Studio Inc., Venice, CA (US)

(21) Appl. No.: 17/798,919

(22) PCT Filed: Feb. 11, 2021
(86) PCT No.: PCT/US2021/017540

§ 371 Date: Aug. 11, 2022

Related U.S. Application Data
(60) Provisional application No. 62/972,872, filed on Feb. 11, 2020.

(51) Int. Cl. G06V 10/80; G06V 20/58; G08G 1/14; H04W 4/021; H04W 4/40

(52) U.S. Cl. CPC G06V 10/803; G06V 20/586; G08G 1/149; H04W 4/021; H04W 4/40

(57) ABSTRACT

A system includes a processor and a memory in communication with the processor, the memory storing instructions that when executed by the processor cause the processor to receive from a portable device coupled to a vehicle one or more images and at least one sensor datum, compute based, at least in part, upon the one or more images and at least one sensor datum a pose estimate of the vehicle, identify based, at least in part, upon the pose estimate a geofence containing the pose estimate; and if the geofence comprises, at least in part, a parking zone, transmit a parking validation to the portable device.

### CROSS REFERENCE TO RELATED APPLICATIONS

This application claims the benefit of U.S. Provisional Patent Appl. No. 62/972,872, filed Feb. 11, 2020, the entire disclosure of which is incorporated herein by reference.

### TECHNICAL FIELD

The present disclosure relates generally to systems and methods for enabling spatial application involving micromobility vehicles.

### BACKGROUND

Systems require knowledge of the physical environment in which they operate and their position with respect to that environment in order to inform their functionality. Examples include micromobility, augmented reality, and robotics among others. All spatial applications have the same fundamental need for high resolution semantic maps and precise positioning.

There is therefore a need for a system and a method for provide a complete end-to-end solution for acquiring such high resolution semantic maps and precise positioning.

### SUMMARY

In accordance with an exemplary and non-limiting embodiment a system, comprises a processor and a memory in communication with the processor, the memory storing instructions that when executed by the processor cause the processor to receive from a portable device coupled to a vehicle one or more images and at least one sensor datum. compute based, at least in part, upon the one or more images and at least one sensor datum a pose estimate of the vehicle, identify based, at least in part, upon the pose estimate a geofence containing the pose estimate; and if the geofence comprises, at least in part, a parking zone, transmit a parking validation to the portable device.

In accordance with an exemplary and non-limiting embodiment a method comprises receiving from a portable device coupled to a vehicle one or more images and at least one sensor datum, computing based, at least in part, upon the one or more images and at least one sensor datum a pose estimate of the vehicle, identifying based, at least in part, upon the pose estimate a geofence containing the pose estimate and if the geofence comprises, at least in part, a parking zone, transmitting a parking validation to the portable device.

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an exemplary and non-limiting embodiment of a system.

FIG. 2 illustrates an exemplary and non-limiting embodiment of an image collection method.

FIG. 3 illustrates an exemplary and non-limiting embodiment of an image collection method.

FIG. 4 illustrates an exemplary and non-limiting embodiment of a block diagram of a processing pipeline.

FIG. 5 illustrates an exemplary and non-limiting embodiment of a block diagram of an image reconstruction processing pipeline.

FIG. 6 illustrates an exemplary and non-limiting embodiment of a block diagram of a self-updating processing pipeline.

FIG. 7 illustrates an exemplary and non-limiting embodiment of a block diagram of a CPS algorithm.

FIG. 8 illustrates an exemplary and non-limiting embodiment of an embedded system.

FIG. 9 illustrates an exemplary and non-limiting embodiment of an embedded system.

FIG. 10 illustrates an exemplary and non-limiting embodiment of an embedded system.

FIG. 11 illustrates an exemplary and non-limiting embodiment of a block diagram of a method for developing microgeofences.

FIG. 12 illustrates an exemplary and non-limiting embodiment of method steps for validating parking.

FIG. 13 illustrates an exemplary and non-limiting embodiment of a block diagram of a method for validating parking.

FIG. 14 illustrates an exemplary and non-limiting embodiment of a block diagram of a method for validating parking.

FIG. 15 illustrates an exemplary and non-limiting embodiment of a design concept for providing augmented reality navigation through a mobile device.

FIG. 16 illustrates an exemplary and non-limiting embodiment of a block diagram of a method for providing augmented reality navigation through a mobile device.

FIG. 17 illustrates an exemplary and non-limiting embodiment of CPS compared to GPS.

FIG. 18 illustrates an exemplary and non-limiting embodiment of a block diagram of a method for providing positioning and tracking of micromobility vehicles.

FIG. 19 illustrates an exemplary and non-limiting embodiment of a block diagram of a method for controlling the throttle and brake on a micromobility vehicle.

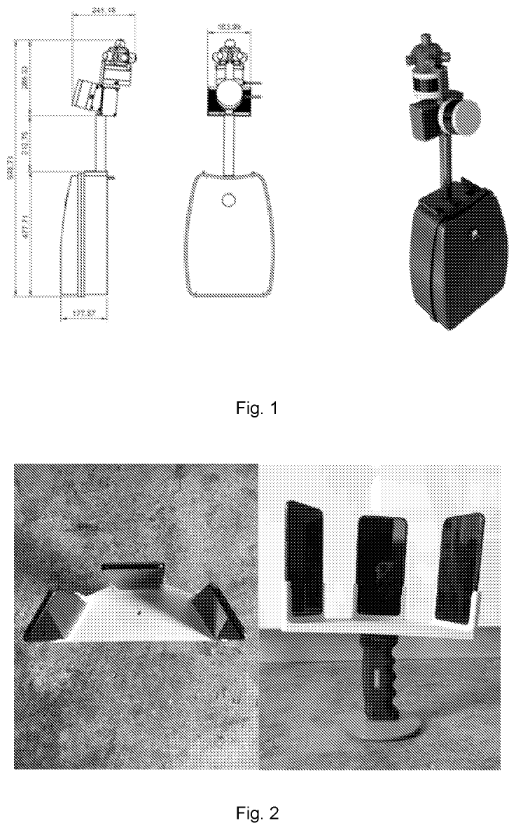

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

These drawings may not be drawn to scale and may not precisely reflect structure or performance characteristics of any given exemplary implementation, and should not be interpreted as defining or limiting the range of values or properties encompassed by exemplary implementations.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

To generate world-scale, semantic maps, data must first be captured of the physical environment. Data may come from a variety of visual, inertial, and environmental sensors.

In accordance with exemplary and non-limiting embodiments, a mapping system may quickly and accurately map physical spaces in the form of world-scale (i.e., 1:1 scale) 3D reconstructions and geo-registered 360 imagery. Such a system is applicable for mapping large outdoor spaces as well as indoor spaces of various types.

Examples of applicable environments in which the system may operate include urban environments (e.g., streets and sidewalks), nature environments (e.g., forests, parks and caves) and indoor environments (e.g., offices, warehouses and homes).

The system may contain an array of time-synchronized sensors including, but not limited to, LiDAR laser ranging, 2D RGB cameras, IMU, GPS, Wifi and Cellular. The system may collect raw data from the sensors including, but not limited to, Laser ranging data, 2D RGB images, GPS readings, Linear Acceleration, Rotational velocity, Wifi access point SSIDs and signal strength and Cellular tower IDs and signal strength

The system may be operated in a variety of ways. For example, a mobile application may be available that communicates via Wifi to send control inputs. During capture, it may show in real-time or near real-time the path travelled by the system and visualizations of the reconstructed map. It may further provide information on the state of the system and sensors. In other embodiments, a computer may be connected directly to the system over Ethernet, USB, or Serial to send control inputs and receive feedback on the state of the system. In other embodiments, an API may be provided that allows remote control of the system over a data connection. The server may run on an embedded computer within the system. In other embodiments, a physical button may provided on the system to start and stop data capture. The system may be powered on to immediately begin data capture.

The system may be mounted in several ways including, but not limited to, (1) hand-carried by a user, (2) a backpack, harness, or other personal packing rig, (3) scooter, bicycle, or other personal mobility solution, and/or (4) autonomous robotics such as rovers and drone.

### Image Collection

2D images may be used to generate world-scale, semantic 3D reconstructions. There is now described various exemplary and non-limiting embodiments of several methods of collecting 2D image datasets for this intent.

One collection method uses three mobile devices 202 mounted in a bracket 204 designed to be hand carried by a user as illustrated in FIG. 2. The devices 202 may be mounted on a cradle in which the devices were set at, for example, angles of 30°, 90°, and 150° relative to walking direction.

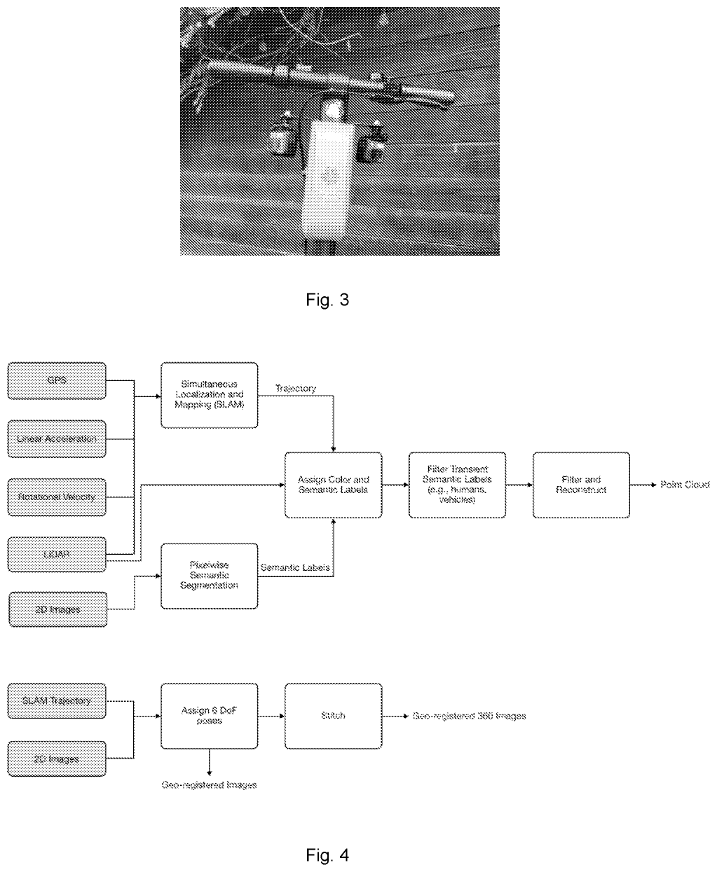

These image collection methods can be generalized to include one or more cameras hand-carried by a user, one or more cameras mounted onto a micromobility vehicle, one or more cameras mounted onto a rover or drone and/or one or more cameras mounted on an automobile. A wide of array of cameras may be used with these collection methods including but not limited to mobile device cameras, machine vision cameras, and action cameras. With reference to FIG. 3, there is illustrated an exemplary and non-limiting embodiment of two cameras mounted to the steering column of a scooter vehicle.

### Crowd Sourcing

Crowd sourced data may be used to generate world-scale, 3D reconstructions as well as to extend and update those maps. Data can be contributed in many forms including, but not limited to, laser ranging data, 2D RGB images, GPS readings, linear Acceleration, rotational velocity, Wifi access point SSIDs and signal strength and/or cellular tower IDs and signal strength. The source of this data may be contributed from any source. Though, it is typical that the data is gathered from Camera Positioning System (CPS) queries. Further, data may be associated with a particular location, device, sensor, and/or time.

### Data Processing Methods

Data may be processed into a number of derived formats through a data processing pipeline as illustrated in the exemplary embodiment of FIG. 4.
Outputs may include:
   Point cloud—A collection of vertices in 3D space with color and semantic class labels.
   Registered imagery—2D Images are assigned global position and orientation. The images are provided from individuals cameras and stitched into 360 images.
   Overhead projection—A top down (relative to gravity) orthographic view of the mapped area.
   Camera Positioning System (CPS) maps—A CPS map is a binary data format that contains machine-readable data for visual positioning.
   Mesh—A mesh is a collection of vertices, edges, and faces that describe the shape of a 3D object. They are used in 3D rendering engines for purposes including modeling, computer generated graphics, game level design, and augmented reality occlusion and physics.
   BIM—An intelligent 3D model-based process that gives architecture, engineering, and construction (AEC) professionals the insight and tools to more efficiently plan, design, construct, and manage buildings and infrastructure.

The processing pipeline may run in real-time or near real-time on the system as the data is collected or in an offline capacity at a later time either on the system or another computer system.

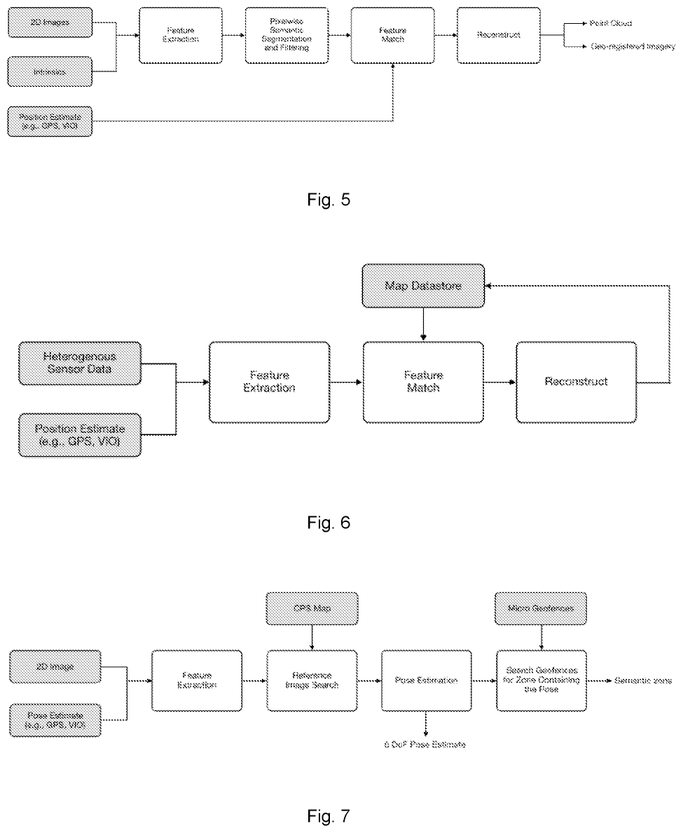

In accordance with exemplary and non-limiting embodiments, a method for reconstructing world-scale, semantic maps from collections of 2D images is described. The images may come from a data collection effort as described above or from a heterogenous crowd source data set as illustrated with reference to FIG. 5.

Physical environments are heavily prone to temporal change such as degradation, construction, and other alterations. To maintain its integrity and utility, a map may be updated in response to change. Spatial applications have a fundamental need to access the map for positioning and contextual awareness. Typically, these applications produce data which may be used to update and extend the underlying map. In this way, maps become self-updating through their usage. Similarly, dedicated collection campaigns can also produce data which is used to update the map as illustrated with reference to FIG. 6.

While automatic semantic segmentation may be incorporated into the aforementioned map processing pipelines, it may be necessary to have humans perform additional annotation and adjudication of semantic labels. To this end, a tool has been developed to enable efficient execution of this functionality.

The tool provides an intuitive user interface in a web browser with drawing tools to create, replace, update, and delete semantic labels. The user may cycle between views including ground-perspective images, point cloud projections, and satellite images. The user actions may be logged along with data input and output in a manner to support the training of autonomous systems (i.e., neural networks) with the goal of fully automating the task.

In addition to high precision 3D maps, spatial applications may further require high precision positioning solutions. Exemplary embodiments of a Camera Positioning System (CPS) is capable of computing the 6 Degree-of-Freedom (Doff) pose (i.e., position and orientation) from a 2D image with centimeter-level accuracy. The pose may be further transformed into a global coordinate system with heading, pitch, and roll. In addition, the semantic zone (i.e., street, sidewalk, bike lane, ramp, etc.) which corresponds to that pose may be returned along with it as illustrated with reference to FIG. 7.

CPS may be composed of these exemplary primary modules:
Feature extraction—A deep learning model may extract unique feature descriptors from query images. It may be trained on a large sample of geographic images which vary in lighting and environmental conditions.
Reference image search—The feature descriptors from the feature extraction module may be used to search a database of images comprising a CPS map for candidates expected to express a high visual overlap with the query image.
Pose estimation—The query image may be compared to the reference images by finding correspondences between the query and reference images. A random sampling technique may be used to refine the transformation between the correspondences. Next, a 6 Dof Pose may be computed from the refined correspondences. Finally, a refinement approach may be used to minimize the error in the pose estimate.
Search for zone containing—Once a pose estimate is available, that location may be used to search a dataset of micro geofences to determine the semantic zone(s) in which the pose is contained.

CPS may be accessed via an API hosted on a web server. It is also possible to run in an embedded system such as a mobile device, Head Mounted Display (HMD), or IoT system (e.g., micromobility vehicle, robot, etc.).

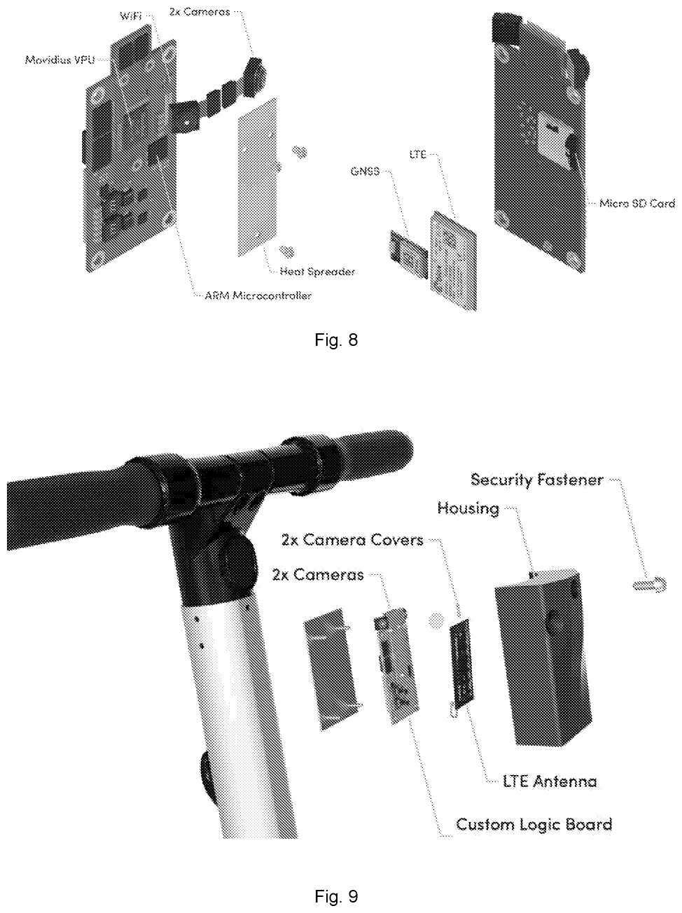

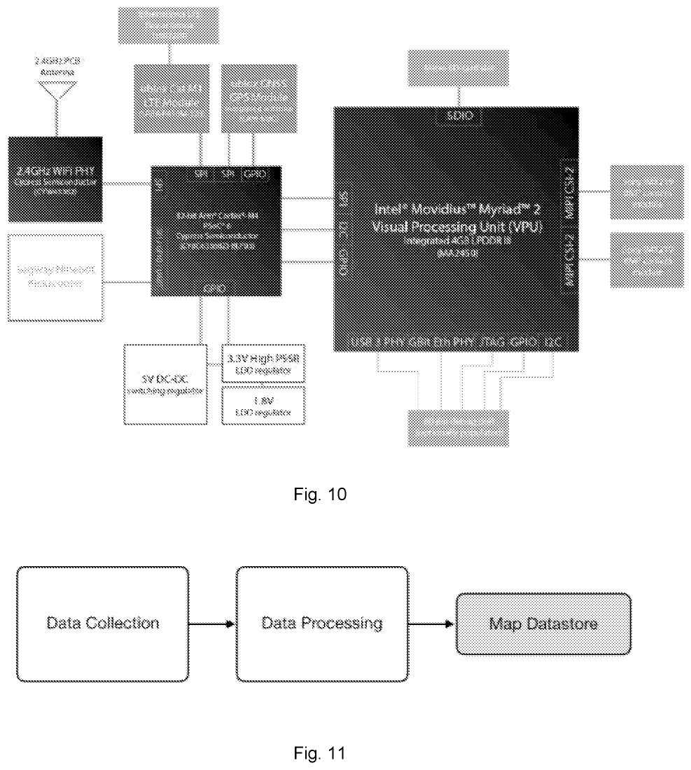

A system which runs CPS fully embedded may be affixed directly to micromobility vehicles, robots, personnel, and any other applications which precise global positioning as illustrated with reference to FIGS. 8 and 9. The map may be stored in onboard disk storage such that it does not rely on physical infrastructure or a data connection. With refere3nce to FIG. 10, there is illustrated an exemplary and non-limiting embodiment of a block diagram of an embedded system adapted to run CPS.

Micromobility is a category of modes of transport that are provided by very light vehicles such as electric scooters, electric skateboards, shared bicycles and electric pedal assisted, peeled, bicycles. Typically, these mobility modalities are used to travel shorter distances around cities, often to or from another mode of transportation (bus, train, or car). Users typically rent such a vehicle for a short period of time using an app.

Micromobility vehicles operate primarily in urban environments where it is difficult to track the vehicles due to degraded GPS and unreliable data communication. Furthermore, cities are imposing regulations on micromobility vehicles to prevent them from riding on in illegal areas (e.g., sidewalks) and parking illegally (e.g., outside of designated parking corrals).

Simply put, current GPS and mapping technology do not have the precision necessary for micromobility vehicles. This lack of precision results in many issues, including, (1) operators cannot validate parking, (2) operators cannot prevent riders from riding on sidewalks, (3) riders have difficulty locating vehicles, (4) chargers/operators have difficulty locating vehicles, and/or (5) chargers falsify deployments.

With more precise maps and positioning, micromobility operators may realize benefits such as (1) parking validation—vehicles can be validated to be parked within legal zones and corrals, (2) prevent riding in illegal areas—apply throttle and brake controls to improve safety for riders and pedestrians when riding in illegal zones (e.g., sidewalks, access ramps, etc.), (3) rider experience—Riders will reliably and quickly locate vehicles thereby increasing ridership, (4) rider safety-improved contextual awareness of the operating zone will serve as vital feedback for users and vehicle control logic, for instance, a scooter may be automatically slowed when entering a pedestrian zone, (5) operational efficiency—similar to riders, chargers will reliably and quickly locate vehicles thereby speeding up operations, and/or vehicle lifetime—better tracking on vehicles will help mitigate vandalism and theft.

Cities and micromobility operators will often implement parking zones (or “corrals”) in which vehicles are meant to be parked at the completion of a ride. These zones are typically small, on the order of 3 to 5 meters long by 1 to 2 meters wide. They may be located on sidewalks, streets, or other areas. The boundaries are typically denoted by painted lines or sometimes by physical markers and barriers. Location of the zones may be further indicated to the user on a map in a mobile application.

Given the relatively small size of these zones, it has proven difficult to determine if a vehicle is correctly parked in a designated parking zone due to, for example, available zones may not be marked on a map or marked with incorrect dimensions and/or a lack of precision of GPS.

If operators do not validate parking, several issues may result including fines and impounding by the city or governing authority and/or blocked throughways which cause pedestrian safety issues and violate accessibility mandates.

There is herein provided methods to solve parking validation for micromobility. In a more general sense, methods enable determining the semantic zone (or “micro geofence”) location of a vehicle.

In order to validate parking and by extension position within micro geofences, an accurate map must be generated. As described above, a map may be generated with centimeter-level accurate geofences. The geofences may be assigned labels from a taxonomy of urban area types such as: Street, Sidewalk, Furniture, Crosswalk, Access ramp, Mobility Parking, Auto Parking, Bus Stop, Train Stop, Trolley, Planter, Bike Lane, Train Tracks, Park, Driveway, Stairs, and more. The micro geofences and associated labels may be stored in a geospatial markup format such as GeoJSON or KML. These labels may then be assigned to position estimates computed by the Camera Positioning System (CPS). With reference to FIG. 11, there is illustrated an exemplary block diagram of a process for developing centimeter-level accurate microgeofences for parking validation of micromobility vehicles and other applications.

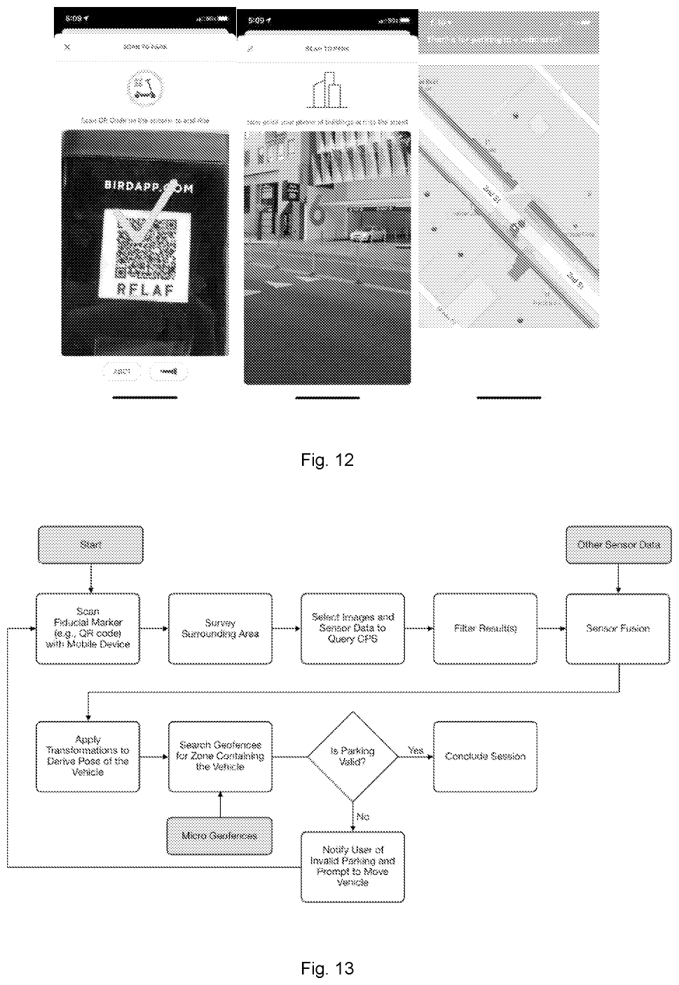

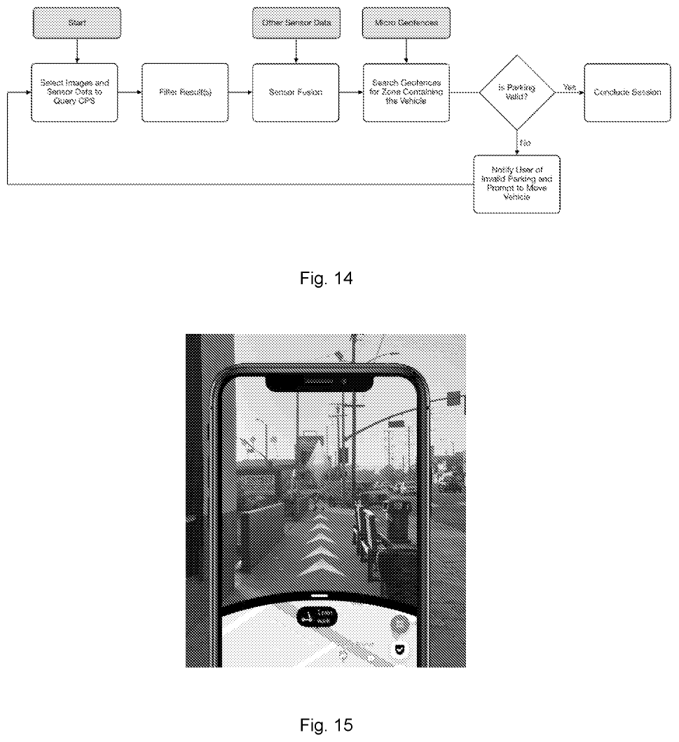

One challenge of micromobility vehicles is the tight revenue margins due to the capital and operational expenses of operating a fleet. Thus, a method is provided for parking validation of a vehicle which requires no additional hardware on the vehicle or physical infrastructure in the environment. It also is patterned after the existing user experience flows prevalent in the industry. With reference to FIGS. 13 and 14, there is illustrated a method for validating parking of micromobility vehicles using a mobile device and CPS. FIG. 12 (left) illustrates a user scanning a QR code. At center, a survey of the surrounding area is conducted using a camera. At right, parking is validated by showing a position of a vehicle within microgeofences.

The method is as follows:

At the conclusion of the ride, the user opens the mobile application which provides access to the vehicle.

A user interface is presented with a live camera feed. If visual-inertial odometry is available on the device (e.g., ARKit on iOS, ARCore on Android), then motion tracking is enabled as well. The user scans a QR code or other fiducial marker of a known size that is affixed rigidly to the vehicle.

The user pans the device upward to survey the surrounding environment through the camera.

While the user is panning the device, images and other sensor data (e.g., GPS, motion tracking, linear acceleration, etc.) may be automatically captured. An algorithm may be used to select images well suited for CPS based on perspective (e.g., pitch of device, motion of device), image quality (e.g., blur and exposure), and other factors.

Images and sensor data may be used to query CPS to determine the precise position of the phone. One or more images may be used to arrive at a pose estimate. CPS may be queried over an API through a data connection or run locally on the device.

To further improve the estimate, results of CPS queries may be fused through Bayesian filtering or another statistical method with other sensor data available on the mobile device such as linear acceleration, rotational velocity, GPS, heading, and visual-inertial odometry among others.

The position of the micromobility vehicle may be computed by applying known transformations between the vehicle and the mobile device. The pose of the mobile device may be computed by CPS. The pose of mobile device at the moment when the fiducial marker (i.e., QR code) was scanned may computed by applying the inverse of the mobile device motion. The pose of the fiducial marker may be derived by computing a geometric pose estimate given the scan image and the known size of the fiducial and then applying that transformation. Finally, the pose of the vehicle may be computed by applying the known transformation from the rigidly affixed fiducial to any desired reference point on the vehicle.

The micro geofences are searched for the geofence that contains the vehicle pose estimate.

If the pose estimate is contained within a parking zone, the user interface alerts the user that the parking has been validated and the session may end. If the pose estimate is not contained within the parking zone, the user may be warned they are parking illegally, told how far the vehicle is from a valid parking area, provided directions to a valid parking area, and/or asked to move the vehicle before ending the ride.

This method can also be used in other contexts such as when, for example, operator personnel are dropping off, charging, or performing service on vehicles and when regulation enforcement agencies (e.g., city parking officials) are tracking vehicles and creating a record of infractions.

With reference to FIG. 14, there is illustrated an exemplary embodiment of a method for validating parking of micromobility vehicles using cameras and sensors equipped on the vehicle.

The method is as follows:
1. The user may select to conclude their ride session.
2. The vehicle nay query CPS using one or more images and sensor data. CPS may be queried over an API through a data connection or run locally on the vehicle. The result is the direct pose of vehicle and requires no further transformations.
3. To further improve the estimate, results of CPS queries may be fused through Bayesian filtering or another statistical method with other sensor data available on the vehicle such as linear acceleration, rotational velocity, GPS, speedometer, heading, and odometry among others.
4. The micro geofences may be searched for the geofence that contains the vehicle pose estimate.

If the pose estimate is contained within a parking zone, the user interface alerts the user that the parking has been validated and the session may end. If the pose estimate is not contained within the parking zone, the user may be warned they are parking illegally, told how far the vehicle is from a valid parking area, provided directions to a valid parking area, and/or asked to move the vehicle before ending the ride.

Users can often have difficulty finding micromobility vehicles when they are in need of transport. This may occur because they may not be aware of where parking zones are located and/or whether any vehicles are near them. Through the use of CPS, navigation may be supplied to users through augmented reality on a mobile device.

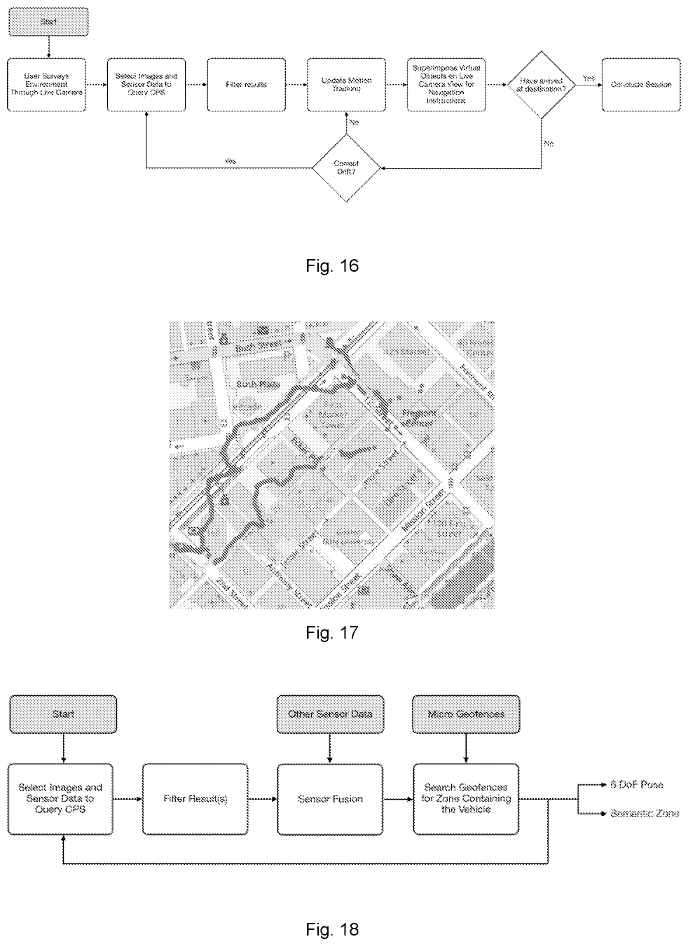

With reference to FIG. 15, there is illustrated an exemplary embodiment of a design concept for providing augmented reality navigation through a mobile device to locate micromobility vehicles and semantic zones. With reference to FIG. 16, there is illustrated an exemplary embodiment of a method for providing augmented reality navigation through a mobile device to locate micromobility vehicles and semantic zones.

The method is as follows:
1. A user interface may be presented with a live camera feed. If visual-inertial odometry is available on the device (e.g., ARKit on iOS, ARCore on Android), then motion tracking may be enabled as well.
2. The user surveys the surrounding environment through the camera.
3. While the user is panning the device, images and other sensor data (e.g., GPS, motion tracking, linear acceleration, etc.) may be automatically captured. An algorithm may be used to select images well suited for CPS based on perspective (e.g., pitch of device, motion of device), image quality (e.g., blur and exposure), and other factors.
4. Images and sensor data may be used to query CPS to determine the precise position of the phone. One or more images may be used to arrive at a pose estimate. CPS may be queried over an API through a data connection or run locally on the device.
5. To further improve the estimate, results of CPS queries may be fused through Bayesian filtering or another statistical method with other sensor data available on the mobile device such as linear acceleration, rotational velocity, GPS, heading, and visual-inertial odometry among others.
6. The resulting 6 DoF pose of the device may be used to set the global frame of reference within the 3D rendering engine for augmented reality. This in effect aligns the virtual assets (for navigation) with the view perspective of the user.
7. Virtual objects may be superimposed on top of the live camera feed to indicate the directions to the user on how to navigate to a particular vehicle or zone.
8. While the user is navigating towards the destination, onboard visual-inertial odometry (e.g., ARKit on iOS, and ARCore on Android) provides motion tracking to move virtual objects within the view perspective. Additional queries to CPS may be used to provide new position estimates and drift correction on the motion tracking.

Similarly, operator personnel may use such functionality to navigate to vehicles for servicing or micro geofence zones for drop-offs.

Positioning and tracking of micromobility vehicles have proven to be difficult and unreliable due to the lack of precision of GPS. It is desirable to have high precision positioning and tracking of vehicles such that advanced functionality may be enabled including parking validation, throttle and break control within micro geofences, detection of moving violations, and autonomous operation among others. The use of CPS with cameras and sensors embedded in micromobility vehicles is able to provide the level of precision necessary for these features.

With reference to FIG. 17, CPS (green) is compared to GPS (red) as a vehicle is tracked around streets in San Francisco, Calif. CPS is shown to have an order of magnitude higher precision than GPS which enables the vehicle system to whether it is on a street or sidewalk and what side of the street.

With reference to FIG. 18, there is illustrated and exemplary and non-limiting method for precise positioning and tracking of micromobility vehicles using high accuracy semantic maps and precise positioning.

The method is as follows:
1. The vehicle queries CPS using one or more images and sensor data. CPS may be queried over an API through a data connection or run locally on the vehicle. The result is the global position and orientation of the vehicle.
2. To further improve the estimates, results of CPS queries may be fused through Bayesian filtering or another statistical method with other sensor data available on the vehicle such as linear acceleration, rotational velocity, GPS, speedometer, heading, and odometry among others.
3. The micro geofences may be searched for the geofence that contains the vehicle pose estimate.

Cities are creating regulations to prevent micromobility vehicles from being ridden in certain areas (e.g., sidewalks) which can pose a safety threat. In a general sense, it is desirable to be able to denote micro geofences in which vehicles cannot be ridden or ridden at a reduced rate. By combining the high accuracy micro geofences and the precise positioning technology vehicles may be dynamically controlled when entering and exiting micro geofenced zones.

Examples include (1) limiting vehicles to 5 mph on a college campus, (2) no riding on sidewalks and (3) no riding on one side of the street during a period of construction.

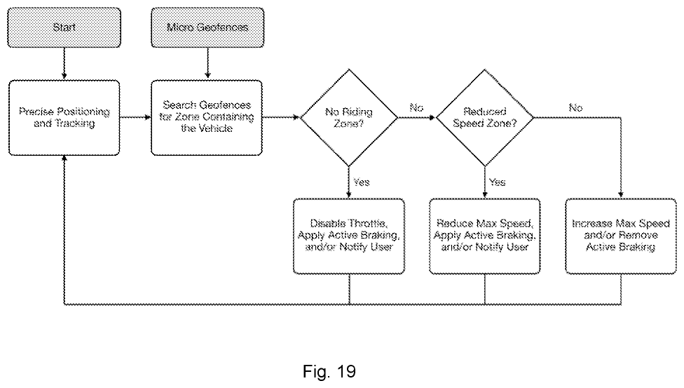

With reference to FIG. 19, there is illustrated and exemplary and non-limiting method for controlling the throttle and brake on a micromobility vehicle using a combination of high accuracy micro geofences and precise CPS.

The method is as follows:
1. The vehicle begins precise positioning and tracking as described above.
2. The micro geofences may be searched for the geofence that contains the vehicle pose estimate.
3. If the vehicle is in a zone that is denoted as “no riding” zone, the throttle may be shut off. Optionally, active braking may also be applied. The user may also be notified by light or sound mechanisms.
4. If the vehicle is in a zone that is denoted as a “reduced speed” zone, the max speed will may be reduced. Optionally, active braking may be applied if the current speed is above the reduced speed limit. The user may also be notified by light or sound mechanisms.
5. If the zone has no restrictions, the vehicle max speed may be increased, and active braking may be turned off.

The precise positioning and tracking functionality described above may also be used to improve autonomous operation of micromobility vehicles. When combined with high accuracy semantic maps, an array of possible autonomous functionality is enabled such as path planning for repositioning, hailing, pickup, and charging.

Another advanced feature of micromobility vehicles that may be enabled by embedding computer vision technology into the vehicle is pedestrian collision detection. When a pedestrian is recognized as in the path of the vehicle, actions may be taken to prevent a collision such as disabling the throttle, applying active braking, and alerting the rider.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage, such as, e.g., volatile or non-volatile storage.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein

What is claimed:

1. A system, comprising:
a processor; and
a memory in communication with the processor, the memory storing instructions that when executed by the processor cause the processor to:
receive from a portable device coupled to a vehicle one or more images and at least one sensor datum;
compute based, at least in part, upon the one or more images and at least one sensor datum a pose estimate of the vehicle;
identify based, at least in part, upon the pose estimate a geofence containing the pose estimate; and
if the geofence comprises, at least in part, a parking zone, transmit a parking validation to the portable device.

2. The system of claim 1, wherein the processor is further caused to fuse the computed pose estimate via the application of a statistical method with at least one other sensor datum of the vehicle.

3. The system of claim 2, wherein the statistical method comprises Bayesian filtering.

4. The system of claim 2, wherein the at least one other sensor datum is selected from the group consisting of linear acceleration, rotational velocity, GPS, speed, heading, and distance.

5. The system of claim 1, wherein the processor is further caused to, if the geofence does not comprise a parking zone, transmit information to the portable device indicative of the vehicle not being located in a parking area.

6. The system of claim 5, wherein the transmitted information comprises information indicating a distance to a valid parking area.

7. The system of claim 5, wherein the transmitted information comprises information indicating directions to a valid parking area.

8. The system of claim 5, wherein the transmitted information comprises information indicating a request to move the vehicle.

9. A method comprising:
receiving from a portable device coupled to a vehicle one or more images and at least one sensor datum;
computing based, at least in part, upon the one or more images and at least one sensor datum a pose estimate of the vehicle;
identifying based, at least in part, upon the pose estimate a geofence containing the pose estimate; and
if the geofence comprises, at least in part, a parking zone, transmitting a parking validation to the portable device.

10. The method of claim 9, further comprising fusing the computed pose estimate via the application of a statistical method with at least one other sensor datum of the vehicle.

11. The method of claim 10, wherein the statistical method comprises Bayesian filtering.

12. The method of claim 10, wherein the at least one other sensor datum is selected from the group consisting of linear acceleration, rotational velocity, GPS, speed, heading, and distance.

13. The method of claim 9, further comprising, if the geofence does not comprise a parking zone, transmitting information to the portable device indicative of the vehicle not being located in a parking area.

14. The method of claim 13, wherein the transmitted information comprises information indicating a distance to a valid parking area.

15. The method of claim 13, wherein the transmitted information comprises information indicating directions to a valid parking area.

16. The method of claim 13, wherein the transmitted information comprises information indicating a request to move the vehicle.
